(19) United States
(12) Patent Application Publication
(10) Pub. No.: US 2024/0386082 A1
(43) Pub. Date: Nov. 21, 2024

(54) METHOD OF DIGITAL BADGING AND MICRO CREDENTIALING

(71) Applicants: Michael Center, Tazewell, TN (US); Lucinda Dixon, Middlesboro, KY (US)

(72) Inventors: Michael Center, Tazewell, TN (US); Lucinda Dixon, Middlesboro, KY (US)

(21) Appl. No.: 18/666,344

(22) Filed: May 16, 2024

Related U.S. Application Data
(60) Provisional application No. 63/502,443, filed on May 16, 2023.

(51) Int. Cl. G06F 21/31

(52) U.S. Cl. CPC G06F 21/31

(57) ABSTRACT

A method of operating a digital credential platform includes prompting a user to select a credential program including one or more program tasks to be completed by the user for earning a credential and providing an interface for the user to interact with the digital credential platform in order to complete a corresponding one of the program tasks or to submit evidence to the digital credential platform regarding the completion of one of the program tasks by the user. The method further includes awarding a digital credential badge to the user, generating a webpage associated with the awarded digital credential badge and including the display of information relating to the credential earned by the user with respect to the selected credential program, and providing a sharable link to the user that is configured to redirect a third party to the webpage associated with the awarded digital credential badge.

### CROSS-REFERENCE TO PRIOR APPLICATION

This patent application claims priority to U.S. Provisional Patent Application Ser. No. 63/502,443, filed on May 16, 2023, the entire disclosure of which is hereby incorporated herein by reference.

### FIELD

The present invention relates to a digital credential platform configured to generate a sharable digital credential in reaction to a student participant completing a program administered by the digital credential platform.

### BACKGROUND

In an attempt to operate most efficiently, it is typical for educational programs to emphasize the teaching of those concepts and skills that are utilized in solving the most commonly faced problems in the associated field. Unfortunately, despite the improved educational efficiency of this approach, such a situation may result in valuable concepts and skills being deemphasized or ignored by such educational programs because of the limited circumstances under which such concepts or skills are needed in a professional setting. For example, with respect to the medical field, the diagnosis and/or treatment of the most common ailments may be emphasized in an educational setting to the detriment of education regarding rarer ailments, thereby leading to a shortage of knowledge or practical skill when these rarer ailments are eventually encountered by the medical practitioner. Accordingly, the earning of a degree or certification with respect to a relatively broad field does not ensure that the practitioner has the knowledge or skill necessary in solving certain problems faced in practice, despite the practitioner otherwise having the knowledge base and skillset for readily learning and employing suitable techniques in solving such problems.

It has thus become increasingly common for fields of employment to utilize certificates (or other similar forms of documentation) to indicate when a practitioner has acquired the knowledge and skill necessary for addressing these rarer or more specialized circumstances. Such certificates generally communicate that the certified practitioner has exceptional expertise and/or experience in handling such concerns in comparison to a more broadly trained practitioner devoid of such specialized training. For example, a medical practitioner may receive a certificate or the like indicating that the medical practitioner is well trained and competent in carrying out a medical procedure that is otherwise not emphasized during a typical medical school education, thereby informing prospective patients and fellow practitioners that it may be beneficial to request the advice or services of the certified practitioner when such a medical procedure is required.

Unfortunately, the more traditional training and certification process described above presents many concerns that must be addressed. First, there are often a limited number of individuals with the necessary expertise to educate and/or certify those practitioners seeking to broaden their knowledge and skill base, and especially when seeking specialized or narrow training. Second, it is generally very difficult for such practitioners to authenticate that such advanced training has occurred due to the limited means of recording and reporting such achievements. That is, outside of review of a printed certificate or the like, there often does not exist a means for a practitioner to reliably communicate such qualifications to other interested parties, such as prospective employers or customers hoping to research the qualifications of a practitioner. Third, it can be difficult for those not having adequate training in a specific topic to determine the authenticity or value of the certification that the practitioner has received, or the quality of the training leading to such a certification. For example, it may be difficult to determine whether a practitioner has actually received the necessary training in handling a specific problem absent access to a limited number of individuals familiar with the topic in question. It can even be difficult to confirm the details of a resumé or Curriculum Vitae (CV) in the absence of communication with the references cited thereon.

There accordingly exists a need for an improved system and method for administering a training program and for digitally communicating a credential of a practitioner relating to the completion of such a training program by the practitioner.

### SUMMARY OF THE INVENTION

Concordant and congruous with the present invention, a method of digital badging and micro credentialing has surprisingly been discovered.

According to an embodiment of the present invention, a method of operating a digital credential platform includes the steps of prompting a user of the digital credential platform to select a credential program comprising one or more program tasks to be completed by the user with the user earning a credential with respect to the selected credential program upon completion of a predefined quantity or set of the associated program tasks, displaying a listing of the program tasks associated with the selected credential program to the user, and providing an interface for the user to interact with the digital credential platform. The interface may be utilized to complete a corresponding one of the program tasks via the interacting of the user with the digital credential platform or to submit evidence to the digital credential platform regarding the completion of the corresponding one of the program tasks by the user. The method further includes the steps of awarding the user a digital credential badge following a determination that the user has earned the credential with respect to the selected credential program, generating a webpage associated with the awarded digital credential badge, the webpage including the display of information relating to the credential earned by the user with respect to the selected credential program, and providing a sharable link to the user with the sharable link configured to redirect a third party to the webpage associated with the awarded digital credential badge upon interaction of the third party with the sharable link.

### BRIEF DESCRIPTION OF THE DRAWINGS

Having thus described embodiments of the invention in general terms, reference will now be made to the accompanying drawings, wherein:

FIG. 1 illustrates an enterprise system, and environment thereof, according to at least one embodiment; and

FIG. 2 is a flow chart representing a method of operating a digital credential platform according to an embodiment of the present invention.

### DETAILED DESCRIPTION OF EXEMPLARY EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Unless described or implied as exclusive alternatives, features throughout the drawings and descriptions should be taken as cumulative, such that features expressly associated with some particular embodiments can be combined with other embodiments. Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete, and will fully convey the scope of the invention and enable one of ordinary skill in the art to make, use, and practice the invention.

The terms “coupled,” “fixed,” “attached to,” “communicatively coupled to,” “operatively coupled to,” and the like refer to both (i) direct connecting, coupling, fixing, attaching, communicatively coupling; and (ii) indirect connecting coupling, fixing, attaching, communicatively coupling via one or more intermediate components or features, unless otherwise specified herein. “Communicatively coupled to” and “operatively coupled to” can refer to physically and/or electrically related components.

Embodiments of the present invention described herein, with reference to flowchart illustrations and/or block diagrams of methods or apparatuses (the term “apparatus” includes systems and computer program products), will be understood such that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

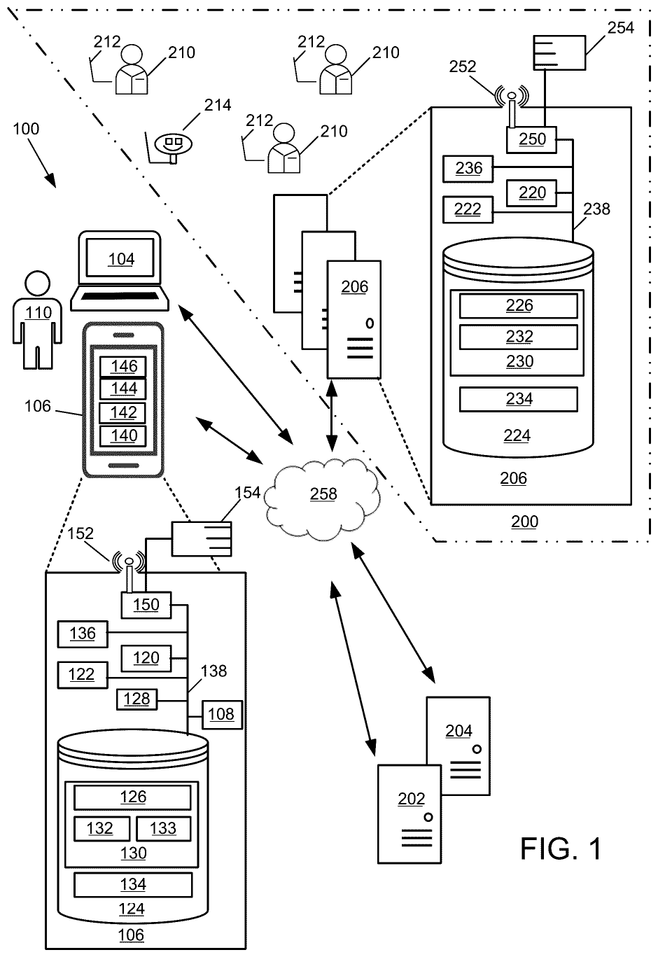

FIG. 1 illustrates a system 100 and environment thereof, according to at least one embodiment, by which a user 110 benefits through use of services and products of an enterprise system 200. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a GPS device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, IOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the illustrated applications 132, 133 are represented as particular examples. The storage device 124 can store various other data items 134, which can include, as non-limiting examples, cached data, user files such as those for pictures, audio and/or video recordings, files downloaded or received from other devices, and other data items preferred by the user or required or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, user input devices and user output devices, which are operatively coupled to the processing device 120. The user output devices include a display 140 (e.g., a liquid crystal display or the like), which can be, as a non-limiting example, a touch screen of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, and/or other input device(s). The user interface may also include a camera 146, such as a digital camera.

Further non-limiting examples include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The mobile device 106 may also include a positioning device 108, which can be for example a global positioning system device (GPS) configured to be used by a positioning system to determine a location of the mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the consumer mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device. As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110 in accordance with the system and method of the present invention. In some examples, the enterprise system 200 offers products, and in other examples, the enterprise system 200 offers services. Use of “service(s)” or “product(s)” thus relates to either or both in these descriptions. In non-limiting examples, services and products include information services and products, custom services and products, predefined or pre-offered services and products, consulting services and products, or advising services and products.

To provide access to, or information regarding, some or all the services and products of the enterprise system 200, any number of human agents 210, can be employed, utilized, authorized or referred by the enterprise system 200. Such human agents 210 can be, as non-limiting examples, online customer service assistants available to users 110, advisors, project managers, sales team members, technicians, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matters of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, IOS, Android, and any known other operating system used on personal computer, central computing systems, phones, and other devices.

The user devices, referring to either or both of the mobile device 104 and computing device 106, the agent devices 212, and the enterprise computing system 206, which may be one or any number centrally located or distributed, are in communication through one or more networks, referenced as network 258 in FIG. 1. As used hereinafter, it is assumed that references to the enterprise system 200 performing an action related to the collection, transfer, or analysis of data is referring to an action being taken by the appropriate components of the computing system 206 of the enterprise system 200 as described herein. Similarly, references to such actions being performed by the computing devices 104, 106 or the external systems 202, 204 should be assumed to be performed by corresponding components thereof.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience, but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

Two external systems 202 and 204 are expressly illustrated in FIG. 1, representing any number and variety of data sources, users, consumers, customers, business entities, banking systems, government entities, clubs, and groups of any size are all within the scope of the descriptions. In at least one example, the external systems 202 and 204 represent third party sources of data associated with a specific site or location, such as repositories of such data or entities responsible for the collection of such data.

In certain embodiments, one or more of the systems such as the user device 106, the enterprise system 200, and/or the external systems 202 and 204 are, include, or utilize virtual resources. In some cases, such virtual resources are considered cloud resources or virtual machines. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

The present disclosure relates to a method for tracking, authenticating, and incentivizing the acquisition of professional knowledge and/or skills via the use of a digital credential platform, wherein the digital credential platform is associated with the enterprise system 200 of FIG. 1. The digital credential platform forms an interface for interactions with a person that has previously or is currently seeking to complete an educational/training program for which authenticated credentials are desired. As utilized hereinafter, such a person seeking the authenticated credential may be generally referred to as a “participant” in an associated educational/training program, wherein such a participant may act as the user 110 having one of the user devices 104, 106 shown and described in FIG. 1. The digital credential platform is also interacted with and managed by at least one human agent 210 associated with the enterprise system 200, wherein each of the human agents 210 may be representative of an expert with respect to at least one topic or skill for which a credential is being sought by one of the participants. The credentials described herein may be associated with the participant providing evidence of adequate ability with respect to any applicable skill or with the participant providing evidence of adequate knowledge with respect to any applicable topic, and is not limited by any of the examples provided herein. References hereinafter to a “skill” that the participant is attempting to master in order to receive a credential from the digital credential platform may refer to the participant being able to adequately complete an associated task or may refer to the participant showing adequate knowledge with respect to an associated topic, hence the use of the term “skill” should be considered to be inclusive of either circumstance, unless noted otherwise.

The digital credential platform is generally described hereinafter as being accessible as a form of software application 132 executable on one of the user devices 104, 106 of the user 110 or potentially one of the agent devices 212 of one of the human agents 210 of the enterprise system 200, but it should be understood that the present invention is not limited to the use of a dedicated software application 132 executable on one of the described user devices 104, 106 or agent devices 212 in carrying out the method according to the present invention. Instead, the features described herein may similarly be accessed via a corresponding website accessible via a web browsing application executable on any of the described user devices 104, 106 or agent devices 212, wherein such a website may include the same or similar interfaces for accomplishing the same tasks as described with respect to the application 132. It is generally assumed hereinafter that the same features of the present invention may be accessible via use of the website accessible via the browser application or the direct use of the software application 132. It should also be generally understood that the website and the software application 132 may include the display of the same data, but may include a different arrangement of such data to best accommodate the configuration of the corresponding user device 104, 106, such as accommodating a specific screen configuration or specific user input method. Any references to the digital credential platform herein may refer to either of the software application 132 or the corresponding website managed by the enterprise system 200 while remaining within the scope of the present invention.

The methods disclosed herein also include references to the computing system 206 storing data or files to the storage device 224 thereof. As utilized herein, the storage device 224 of the computing system 206 is not limited to a storage device exclusively managed by the enterprise system 200, and may instead refer to a third-party data storage device in communication with the computing system 206, or any other form of storage device 224 associated with and accessible by the computing system 206. That is, as opposed to storing all applicable data to a storage medium maintained directly by the enterprise system 200, the enterprise system 200 may utilize an external storage medium managed by a third-party entity for storing such data. The digital credential platform according to the present invention may accordingly utilize cloud-based functions to transfer data between the computing system 206 and any corresponding third-party entity, such as one of the described external systems 202, 204, during navigation of the digital credential platform for sending and/or retrieving the desired data at the desired instance. It is accordingly not critical to the present invention that the acquired data be stored to a specific storage device or location, so long as the digital credential platform routes the desired data to the corresponding user 110 or agent 210 for display thereto in accordance with the novel features of the present invention.

The digital credential platform is navigable in a manner wherein the user 110 may interact with certain text or graphics as depicted on the display of the corresponding user device 104, 106 to cause the digital credential platform to take an action in accordance with the method of the present invention, wherein any text or graphics that the user 110 may interact with may be referred to as the interactive areas of the interface of the digital credential platform. For example, the selection of an interactive area, such as by a touch interaction via use of a touch screen mobile device 106, may cause the appearance of the digital credential platform to change (such as by altering the graphic appearance or the data instantaneously shown on the display), may redirect the user 110 to another page or resource of the digital credential platform for performing other actions or viewing different data, or may cause the digital credential platform to take an action such as sending a communication to the user 110 or uploading a document related to operation of the digital credential platform. The digital credential platform may have substantially any appearance and substantially any navigable layout so long as the digital credential platform is able to carry out the method according to the present invention as described herein. In other words, the digital credential platform may have substantially any format for facilitating the completion of the steps described herein when the user 110 is navigating the digital credential platform, and is not limited to any specific graphic appearance or order of operations in navigating the digital credential platform.

The digital credential platform provides a library of at least one credential program that the user 110 (acting as a participant) may access in attempting to acquire a digital credential. Each credential program refers to an educational program or training program that includes one or more program tasks or program requirements that the user 110 must complete or satisfy in order for the digital credential platform to award the user 110 a digital credential corresponding to the user 110 having acquired the necessary knowledge and/or ability with respect to the topic of the credential program. That is, each of the credential programs comprises a (check) list of tasks or requirements that the user 110 must complete or satisfy in return for the receipt, by the user 110, of a digital credential generated by the digital credential platform and indicative of completion of the corresponding credential program.

The digital credential platform allows the user 110 to monitor his or her progress in completing or satisfying each of the necessary program tasks or program requirements when accessing and viewing the corresponding credential program, such as by providing visual verification of those program tasks/requirements that have been completed and those program tasks/requirements that are still pending and/or uncompleted. As explained in greater detail hereinafter, the digital credential platform also provides an interface for facilitating interactions between the user 110 (via the user device 104, 106 thereof) and the enterprise system 200 (via the computing system 206 thereof) for the user 110 to complete or satisfy a listed program task/requirement via interaction with the digital credential platform and/or for the user 110 to provide evidence that the user 110 has completed or satisfied a listed program task/requirement via actions occurring outside of the interaction of the user 110 with the digital credential platform.

Each of the credential programs may be developed by one or more human agents 210 of the enterprise system 200 based on the expertise of those human agents 210 in the topic of the associated credential program. Each of the human agents 210 acting as a credential program developer does not necessarily need to be an employee or contractor of the enterprise system 200, and may be any person having the necessary qualifications and expertise to develop such a credential program in accordance with the standards of the enterprise system 200. In many circumstances, at least one of the human agents 210 responsible for developing a corresponding credential program has a relationship with a recognized entity associated with expertise in the corresponding topic, such as being a member or representative of a nationally recognized association of practitioners, or the like. For example, the developer of a medical training program may be a member or representative of an entity such as the American Medical Association, as one non-limiting example. The human agent 210 responsible for developing the corresponding credential program selects the program tasks/requirements that must be completed or satisfied in completing the credential program, and may further select the appropriate means by which the participant must interact with the digital credential platform in completing or satisfying all necessary tasks/requirements and/or in providing suitable evidence of the completion or satisfaction of all necessary tasks/requirements.

The different forms of program tasks/requirements associated with completion of the credential program may require a variety of different forms of interactions between the user 110 and the digital credential platform to complete or satisfy each of the respective program tasks/requirements, depending on the circumstances. In some circumstances, the user 110 (when acting as the participant in the credential program) may utilize the digital credential platform as an interface for entering relevant information or for being assessed or tested in attempting to complete or satisfy a given program task/requirement. For example, a credential program may include a program task/requirement relating to the user 110 taking and passing a test showing knowledge in the corresponding topic of the credential program following review of educational materials, and such a test may be accessible via direct interaction between the user 110 and the digital credential platform. In such an example, the user 110 may access a text box for entering written answers to questions of the test, or the user 110 may be presented with an interface for selecting the different options of a multiple-choice test, as the circumstances may require. The user 110 may accordingly be assessed during direct interactions with the digital credential platform.

Each of the credential programs may include one or more program tasks/requirements wherein the user 110 must review educational materials as a condition of the completion of the associated program task/requirement, such as having to read a document or one or more installments of an educational video series, as non-limiting examples. The digital credential platform may accordingly be utilized as a document viewer, video player, or the like for allowing the user 110 to complete/satisfy the associated task/requirement, wherein the progress of the user 110 in reviewing/viewing the necessary educational materials is monitored by the digital credential platform, such as the digital credential platform reporting whether the user 110 has or has not read/watched each of the individual documents/videos forming the program task/requirement. The digital credential platform may also include a feature wherein the user 110 is tested on the contents of the educational materials following the completion of the review of the entirety or a portion thereof, such as testing the user 110 in the form of multiple choice questions based on the contents of a recently completed instructional video with the answers submitted via an interface of the digital credential platform.

In other circumstances, the digital credential platform may be utilized for uploading a file, document, or the like associated with completing or satisfying a program task/requirement or with providing evidence of the same. With renewed reference to the testing example above, the user 110 may choose an option to upload a file to the digital credential platform, such as a document corresponding to a completed test taken by the user 110 with the answers of the user 110 recorded in the document, rather than taking the test via direct interaction with an interface of the digital credential platform. As another example, a program task/requirement may require that the user 110 provide photographic, audio, or video evidence of the user 110 performing an action relating to the skill being assessed by the credential program, such as requiring video evidence of the user 110 performing a newly developed surgical procedure in the form of a playable video file. As a variation of this example, the user 110 may be tasked with uploading such video content in order for a human agent 210 to review and assess the video footage in determining whether the user 110 has the requisite ability in performing the recorded action. As yet another example, the user 110 may upload a file of a document including a signature (or other authenticating information) from a qualified expert in the topic of the credential program, wherein the document includes information relating to the user 110 having completed a task or met a requirement, as attested to by the signature (or other authentication method) originating from the qualified expert. In such an example, the qualified expert may be one of the human agents 210 having developed the credential program or may be an independent expert that is otherwise deemed qualified by the digital credential platform as being able to assess the user 110 in accordance with the given program task/requirement.

According to yet another circumstance, a human agent 210 having a relationship with the digital credential platform may navigate the digital credential platform to indicate or provide evidence of the completion or satisfaction of a program task/requirement by the user 110, as applicable. For example, the human agent 210 may be responsible for grading an in-person test taken by the user 110 as a part of the credential program, and the human agent 210 may then be responsible for entering the score of the user 110 and/or indicating whether the assessed score is indicative of completion or satisfaction of the corresponding program task/requirement. According to another example, the human agent 210 may be responsible for indicating whether the user 110 attended each of a series of necessary training sessions associated with a program task/requirement. The human agent 210 may alternatively be responsible for uploading any of the files or entering any of the information described above as occurring with respect to the user 110, as determined by the circumstances of the corresponding program task/requirement.

A human agent 210 associated with the given credential program may be able to access the submissions of the user 110 to determine whether the user 110 properly completed or satisfied the program task/requirement, such as grading any testing materials originating from the user 110 or reviewing and authenticating any documents uploaded by the user 110, as non-limiting examples. The completion or satisfaction of some program tasks/requirements may accordingly require an action by the user 110 in forming the evidence of the completion or satisfaction of the corresponding program task/requirement as well as an action by one or more human agents 210 in determining whether the evidence submitted by the user 110 meets all of the requirements as set forth by the credential program. In other circumstances, review of certain program tasks/requirements by a human agent 210 may not be required, such as where the digital credential platform can determine the completion of satisfaction of the program task/requirement via computing means or some other objective evaluation.

Each credential program is associated with a digital credential badge that the user 110 earns upon completion of the corresponding credential program. Each digital credential badge is a graphical representation of the digital credential earned by the user 110 following completion of a corresponding credential program, wherein each digital credential badge may be accessed and reviewed by a third party attempting to ascertain the skill or knowledge of the user 110 with respect to the topic of the credential program for which the digital credential badge was earned.

Each digital credential badge may be associated with a respective network address (web address) at which all information associated with the digital credential badge may be accessed and reviewed by the third party, such as when the third party is researching the qualifications of the user 110 in performing a task for the third party. The digital credential platform provides the user 110 the ability to post a link (such as by hyperlink) to the network address of the digital credential badge to allow any third party accessing such a link to view the information associated with the digital credential badge. The link to the network address of the digital credential badge may be provided in any form including the use of text and/or the use of an icon showing the graphical representation of the digital credential. For example, the graphical representation (icon) of the digital credential may have the shape of a police officer badge along with overlaying text indicating the subject of the credential program that has been completed, as one possible example. Other possible shapes may include a ribbon shape, a star shape, a circular shape, etc., as non-limiting examples. The graphical representation (icon) of the digital credential may also include information relating to the achievement level of the user 110 having completed the credential program, such as the graphical representation having a specific color scheme indicating the achievement level of the user 110, such as the use of one of gold (highest level), silver (intermediate level), and bronze (lowest acceptable level) in depicting the icon of the digital credential badge.

The link to the digital credential badge may be utilized in any of a number of different ways to redirect the third party to the information relating to the digital credential in assessing the abilities of the user 110. For example, the user 110 may post the link to the digital credential badge to any of a number of social media platforms in order to show the competency of the user 110 in the given topic, such as the user 110 posting the link to each social media account of a business employing the user 110 or operated by the user 110 to allow others to investigate the qualifications of the user 110. In the same manner, the digital credential badge may be linked on any website having any connection to the user 110, such as the website of any business associated with the user 110, and/or to any email address of the user 110, such as placing the link within the signature line of the professional email address of the user 110. As another example, the user 110 may provide the link within a resumé or CV, and especially a digital resumé or CV accessible via a network connection. A prospective employer may accordingly review the authenticated achievements of the user 110 regarding a topic or skill of particular importance to the prospective employer, wherein the use of a link also allows for additional information to the presented to the prospective employer at another network location such that the resume or CV is not overwhelmed by all information that is displayed at the digital credential badge network address. That is, the digital credential badge and all associated information need not dominate the space occupied by the resumé or CV in taking away from other aspects thereof.

The selection of the network address of a corresponding digital credential badge and the redirection thereto may also provide a graphical representation of any relevant information associated with the corresponding credential program that may be of interest to a party reviewing the credentials of the user 110, such as information relating to the program tasks/requirements that the user 110 completed or satisfied in achieving the corresponding digital credential, information relating to the developers of the credential program and/or any entities having an affiliation or association with the credential program, information relating to the level of achievement of the user 110 relative to other participants in the credential program, information relating to the digital credential platform and/or the enterprise system 200, and information relating to the authenticity of any aspect of the credential program. This may include information regarding the authenticity of any human agents 210 developing the credential program and/or performing tasks relating to assessing the user 110 in determining the outcome of any program task/requirement or the outcome of the credential program as a whole, the authenticity of any entities associated with the credential program (such as professional practitioner associations), the authenticity of the results of the user 110 regarding any tasks/requirements forming the credential program, and/or the authenticity of the digital credential platform and/or enterprise system 200 in administering the digital credential badge for third party review. The developer of the corresponding credential program, such as one of the human agents 210 acting as an expert on the corresponding topic, may be responsible for determining the information that is communicated when accessing the network address of the digital credential badge.

The user 110 utilizes the digital credential platform via the creation of a user account that associates the user 110 with the credential programs the user 110 has fully or partially participated in and the digital credential badges that the user 110 has earned during use of the digital credential platform. The user 110 must provide suitable authentication information to log into the user account, such as providing a password, finger-print scan, facial scan, or the like, to ensure that other parties cannot access the credential program(s) the user 110 is participating in and in the process of completing or satisfying the program tasks/requirements thereof. The log-in process may preferably include the use of two-factor authentication to further ensure the security thereof. Each of the human agents 210 responsible for managing or developing one or more of the credential programs may also be associated with a corresponding administrator account that similarly requires a secure log-in process before any actions can be taken by the human agent 210 in developing a credential program or assessing a participant and/or participant submission, thereby ensuring the authenticity of the development and assessment processes conducted by the digital credential platform.

The storage device 224 of the computing device 206 may be responsible for storing all relevant data described thus far, such as all data relating to the educational materials provided as a part of a credential program, all data corresponding to submissions of the user 110 in completing/satisfying program tasks/requirements, and all data corresponding to the information displayed at the network address associated with each digital credential badge generated by the digital credential platform.

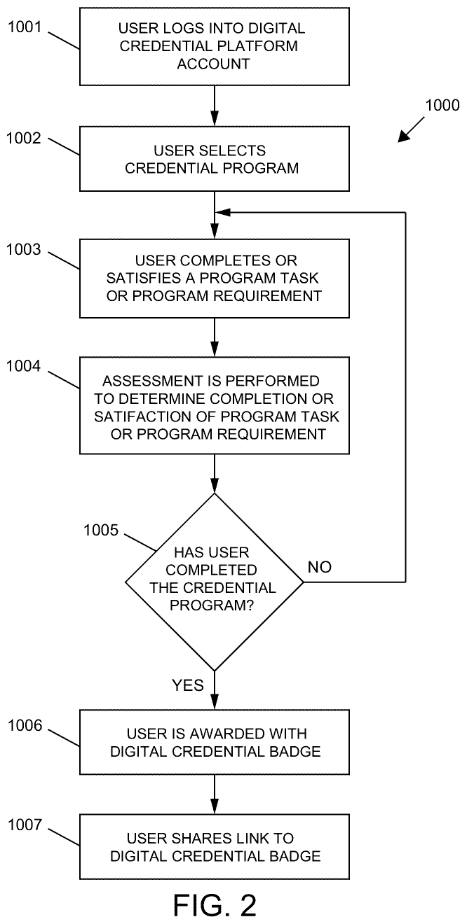

A method 1000 of using the digital credential platform is described hereinafter with reference to the block diagram of FIG. 2. First, in a step 1001 the user 110 logs into the user account of the user 110 as established with the digital credential platform to gain access to the features of the digital credential platform described herein. Next, in a step 1002 the user 110 selects a credential program from the library of credential programs available to the user 110 via the digital credential platform. The step 1002 may include the user 110 discovering and enrolling in a new credential program that has not yet been started or may include the user 110 selecting the credential program from a list of already started or partially completed credential programs for which the user 110 is already enrolled. The discovering of the new credential program may include the user 110 utilizing a search feature of the digital credential platform wherein the user 110 may search for applicable credential programs via any number of different criteria, such as searching by classifications of content, by programs applicable to certain professional practices, by instructor, by educational background, etc., wherein such searches may occur via navigation of lists, icons, or the like, or may occur via a dedicated text search feature. Once the user 110 has selected the desired credential program, the digital credential platform may redirect the user device 104, 106 of the user 110 to view a list of the programs tasks/requirements that the user 110 must complete or satisfy to complete the credential program, and may further disclose the progress of the user 110 with respect to each listed program task/requirement.

Once the user 110 is aware of the program tasks/requirements that the user 110 must complete to earn the corresponding digital credential badge, the user 110 may then perform a step 1003 of completing or satisfying one of the listed program tasks/requirements. As explained above, some program tasks/requirements may be completed or satisfied according to direct interactions between the user 110 and the digital credential platform while other program tasks/requirements may be completed outside of interactions between the user 110 and the digital credential platform with evidence of the completion/satisfaction of each of the program tasks/requirements being submitted to the digital credential platform via one of the user 110 or a human agent 210 associated with the credential program, as the circumstances may warrant. The step 1003 may accordingly include any actions taken by the user 110 in completing or satisfying a program task/requirement according to the requirements of the corresponding credential program (including interacting directly with the digital credential platform) as well as any actions taken by the user 110 in interacting with the digital credential platform regarding a reporting of the completion or satisfaction of a program task/requirement and/or the submission of evidence supporting the completion or satisfaction of a program task/requirement.

According to a step 1004, an assessment is conducted regarding one or more of the user 110, the work product of the user 110, and/or a submission of evidence made by or regarding the user 110 with respect to the completion or satisfaction of the corresponding program task/requirement. In many cases, a human agent 210 managing the credential program may determine whether the user 110 has adequately completed the corresponding program task/requirement, which may include grading a test taken by the user 110, assessing the performance of the user 110 in an image, audio file, or video file, reviewing a document certifying that the user 110 completed a task in the presence of another certified human agent 210, or the like, as non-limiting examples. In some other circumstances, the digital credential platform may conduct the step 1004 according to a predefined program, algorithm, or the like as executed by the computing system 206 and in the absence of the judgment or work product of a human agent 210, such as situations wherein the computing system 206 can objectively and quantitatively evaluate the performance of the user 110 (such as when taking a test via the digital credential platform) with respect to a given program task/requirement. Another example may include the computing system 206 indicating completion of a program task/requirement that is based on the user 110 accessing and watching each video of a video series, or any such condition that can easily be monitored by the digital credential platform.

As shown with reference to the decision box 1005 of FIG. 2, the steps 1003 and 1004 are repeated as many times as necessary until a determination is made that the user 110 has completed the corresponding credential program and/or has reached a new achievement regarding the performance of the user 110 in completing the credential program, such as the user 110 submitting improved evaluations or new evidence with respect to one or more listed program tasks/requirements. In some circumstances, the decision at 1005 may include determining whether the user 110 has completed or achieved a minimum required assessment with respect to each and every available program task/requirement including in the credential program, and in other circumstances the decision at 1005 may include determining whether the user 110 has completed a necessary percentage or subset of the available program tasks/requirements, as specified by the developers of the corresponding credential program. The decision at 1005 may further include the consideration of any factors deemed relevant by the developers of the credential program. The determination at decision box 1005 may be conducted by one or more of the human agents 210 associated with the credential program, by a program, algorithm, or the like of the digital credential platform configured to determine whether the correct number or set of program tasks/requirements had been completed, or by a combination thereof.

In a step 1006, the user 110 is awarded the digital credential badge corresponding to the decision made at 1005, including either of the awarding of a new badge following initial completion of the credential program or the awarding of an updated badge in the case of a new or different evaluation of the user 110. The step 1006 may include the computing system 206 generating the web page associated with the digital credential badge and the user 110 being provided with the link corresponding to the redirection of the third party to the network address (web address) presenting the digital credential badge and all relevant information regarding the user 110 and/or the credential program associated with the digital credential badge.

A step 1007 includes the user 110 sharing the link to the webpage of the digital credential badge via any of the different forms described hereinabove such that a third party may be redirected to said webpage in reviewing the corresponding credential earned by the user 110 and potentially additional details regarding the credential program by which the user 110 earned such a credential. The step 1007 may further include the generation of a graphic icon or the like that is visually perceptible when posted to whatever format the user 110 utilized in sharing the link. The icon generated as a part of step 1007 may itself form the link to the associated webpage such that interaction with the icon, such as by touch screen selection or mouse clicking of the icon, may lead to the redirection of the corresponding device to the viewing of the linked webpage.

The digital credential platform as described herein may be expanded to include the ability of the user 110 to select a credential program that corresponds to a professional development course or a continuing education course for those in the corresponding fields of practice. Such programs may include, but are not limited to, continuing medical education, continuing legal education, and professional development training for those employed by colleges and universities that offer such degree programs. The digital credential platform may be configured to report the completion of such a course to whatever entity is responsible for tracking the completion of such courses.

The digital credential platform as described herein advantageously allows the user 110 to attain a credential with respect to a marketable skill, which may include a skill that is not typically addressed or otherwise mastered in professional program curricula. The digital credential platform also provides a mechanism for the user 110 to authenticate the experiences of the user 110 with respect to skills or achievements that may typically be discussed within a resumé or CV. Because the platform is developed with the help of industry experts and is authenticated by a content expert that aids in awarding the corresponding digital credential badge to the user 110, the user 110 as participant and any potential employers can be confident in the value of the experience the user 110 has gained via completion of the corresponding credential program.

The digital credential platform as described herein also provides incentives for students to pursue expertise outside of the traditional scope of a respective professional program while also providing the framework for the students to follow as they develop new skills. The use of the digital credential platform accordingly increases student confidence with respect to clinical practice, and may also make the students more able to apply for and achieve competitive internships, residencies, and job positions.

From the foregoing description, one ordinarily skilled in the art can easily ascertain the essential characteristics of this invention and, without departing from the spirit and scope thereof, can make various changes and modifications to the invention to adapt it to various usages and conditions.

We claim:

1. A method of operating a digital credential platform comprising:
prompting a user of the digital credential platform to select a credential program comprising one or more program tasks to be completed by the user, wherein the user earns a credential with respect to the credential program upon completion of a predefined quantity or set of the program tasks;
displaying a listing of the program tasks associated with the selected credential program to the user;
providing an interface for the user to interact with the digital credential platform in order for the user to:
complete a corresponding one of the program tasks via the interacting of the user with the digital credential platform, or
submit evidence to the digital credential platform regarding the completion of the corresponding one of the program tasks by the user;
awarding the user a digital credential badge following a determination that the user has earned the credential with respect to the selected credential program;
generating a webpage associated with the awarded digital credential badge, the webpage including the display of information relating to the credential earned by the user with respect to the selected credential program; and
providing a sharable link to the user, the sharable link configured to redirect a third party to the webpage associated with the awarded digital credential badge.

2. The method according to claim 1, wherein the selected credential program is one of a plurality of credential programs offered by the digital credential platform and selectable by the user.

3. The method according to claim 1, wherein the credential program is developed by a subject matter expert in a topic associated with completion of at least one of the program tasks of the credential program.

4. The method according to claim 1, wherein the user must complete all of the listed program tasks to earn the credential associated with the credential program.

5. The method according to claim 1, wherein the displaying of the listing of the program tasks associated with the selected credential program includes displaying the progress of the user with respect to completion of each of the listed program tasks.

6. The method according to claim 1, wherein the user completing a corresponding one of the program tasks via the interacting of the user with the digital credential platform includes the user taking a test via the interface of the digital credential platform.

7. The method according to claim 1, wherein the user completing a corresponding one of the program tasks via the interacting of the user with the digital credential platform includes the user reviewing educational materials via the interface of the digital credential platform.

8. The method according to claim 1, wherein the user submitting evidence to the digital credential platform regarding the completion of the corresponding one of the program tasks by the user includes the user uploading a file to the digital credential platform.

9. The method according to claim 8, wherein the file includes a recording of the user performing an action associated with completing the corresponding one of the program tasks.

10. The method according to claim 9, wherein the recording is one of an audio recording, a visual recording, or an audio/visual recording.

11. The method according to claim 8, wherein the file is a document attesting to the user having performed an action associated with completing the corresponding one of the program tasks.

12. The method according to claim 11, wherein the document is authenticated by a subject matter expert in a topic associated with completion of the corresponding program task.

13. The method according to claim 12, wherein the subject matter expert is registered with the digital credential platform as being qualified to evaluate the user or the action taken by the user.

14. The method according to claim 1, further comprising a step of evaluating the evidence submitted by the user to determine whether the user has completed the corresponding one of the program tasks.

15. The method according to claim 14, wherein the evaluating of the evidence submitted by the user is performed by a subject matter expert in a topic associated with completion of the corresponding program task.

16. The method according to claim 1, wherein the determination that the user has earned the credential with respect to the selected credential program is made by a subject matter expert in a topic associated with the credential program.

17. The method according to claim 1, wherein the sharable link includes a graphic representation of the digital credential badge viewable by the third party.

18. The method according to claim 1, wherein the webpage further includes the display of information relating to one or more program tasks completed by the user for completing the credential program.

19. The method according to claim 1, wherein the webpage further includes the display of information relating to authenticating the credential earned by the user upon completion of the credential program.

20. The method according to claim 1, wherein the sharable link is shared by the user to one or more of a social media platform, a business website, a digital resumć, or a digital CV.
